(19) United States
(12) Patent Application Publication
(10) Pub. No.: US 2025/0166649 A1
(43) Pub. Date: May 22, 2025

(54) USER HOTSPOT DETECTION AND AUDIO/VIDEO CONTENT RECOGNITION

(71) Applicant: Realtek Semiconductor Corp., HsinChu (TW)

(72) Inventors: Yen-Hsun Chu, HsinChu (TW); Yu-Che Kao, HsinChu (TW)

(73) Assignee: Realtek Semiconductor Corp., HsinChu (TW)

(21) Appl. No.: 18/515,190

(22) Filed: Nov. 20, 2023

(51) Int. Cl. G10L 21/0208; G10L 25/63

(52) U.S. Cl. CPC G10L 21/0208; G10L 25/63

(57) ABSTRACT

The present invention provides a processing circuit of an electronic device including an audio/video content generation circuit, a user hotspot detection module and an output module is disclosed. The audio/video content generation circuit is configured to generate audio data and video data to a speaker and a display panel, respectively. The user hotspot detection module is configured to receive a microphone input from a microphone of the electronic device, and detect the microphone input to generate a user hotspot detection result when the speaker plays the audio data and the display panel shows the video data. The output module is configured to store the user hotspot detection result.

### BACKGROUND OF THE INVENTION

### 1. Field of the Invention

The present invention relates to an audio and video playback system.

### 2. Description of the Prior Art

In recent years, media entertainment has become a part of most people's lives, and people spend more time on streaming services such as Youtube, Tiktok, Netflix, and so on. Therefore, how to improve user experience becomes an import topic.

### SUMMARY OF THE INVENTION

It is therefore an objective of the present invention to provide a control method of an electronic device having an audio and video playback system, which can obtain user hotspot detection results and/or audio/video recognition results of a program on the timeline, for reference when the streaming platform subsequently broadcasts this program, to solve the above-mentioned problems.

According to one embodiment of the present invention, a processing circuit of an electronic device comprising an audio/video content generation circuit, a user hotspot detection module and an output module is disclosed. The audio/video content generation circuit is configured to generate audio data and video data to a speaker and a display panel, respectively. The user hotspot detection module is configured to receive a microphone input from a microphone of the electronic device, and detect the microphone input to generate a user hotspot detection result when the speaker plays the audio data and the display panel shows the video data. The output module is configured to store the user hotspot detection result.

According to one embodiment of the present invention, a processing method of an electronic device comprises the steps of: generating audio data and video data to a speaker and a display panel, respectively; receiving a microphone input from a microphone of the electronic device; detecting the microphone input to generate a user hotspot detection result when the speaker plays the audio data and the display panel shows the video data; and storing the user hotspot detection result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to one embodiment of the present invention.

FIG. 2 is a diagram illustrating the user hotspot detection module according to one embodiment of the present invention.

FIG. 3 is a structure of the AI model according to one embodiment of the present invention.

FIG. 4 shows the user hotspot detection results generated by the user hotspot detection module according to one embodiment of the present invention.

FIG. 5 is a diagram illustrating the audio/video content recognition module according to one embodiment of the present invention.

FIG. 6 shows the audio content recognition results generated by the audio/video content recognition module according to one embodiment of the present invention.

### DETAILED DESCRIPTION

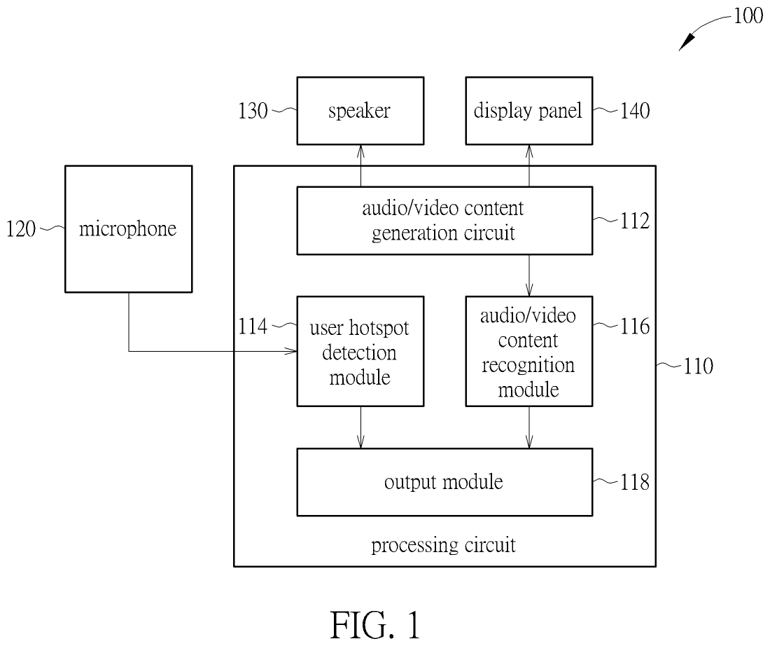

FIG. 1 is a diagram illustrating an electronic device 100 according to one embodiment of the present invention. As shown in FIG. 1, the electronic device 100 comprises a processing circuit 110, a microphone 120, a speaker 130 and a display panel 140, wherein the processing circuit 110 comprises an audio/video content generation circuit 112, a user hotspot detection module 114, an audio/video content recognition module 116 and an output module 118. In this embodiment, the electronic device 100 can be any type of device having an audio and video playback system, such as a television, a notebook, a tablet, a smartphone, or a desktop computer. In addition, the microphone 120 or the speaker 130 may be externally connected to the electronic device 100.

In the processing circuit 110 of the electronic device 100, the audio/video content generation circuit 112 is configured to generate audio data and video data to the speaker 130 and the display panel 140, respectively, for the speaker 130 to play the audio data, and for the display panel 140 to show the video data. The user hotspot detection module 114 can be implemented by using a processor to execute a program code (i.e. an algorithm) or by using a circuitry, and the user hotspot detection module 114 is configured to receive a microphone input from the microphone 120, and detect a human voice of the microphone input to generate user hotspot detection results when the speaker 130 plays the audio data and the display panel 140 shows the video data. The audio/video content recognition module 116 can be implemented by using a processor to execute a program code or by using a circuitry, and the audio/video content recognition module 116 is configured to recognize the audio/video content of the audio/video data to generate audio/video content recognition results, wherein the audio content or the video content may be obtained from the audio/video content generation circuit 112. The output module 118 can be implemented by using a processor to execute a program code or by using a circuitry, and the output circuit 118 is configured to receive the user hotspot detection results and the audio/video content recognition results to generate output information, wherein the output information may be stored in a storage device within the electronic device 100, or the output information may be transmitted to a server via Internet.

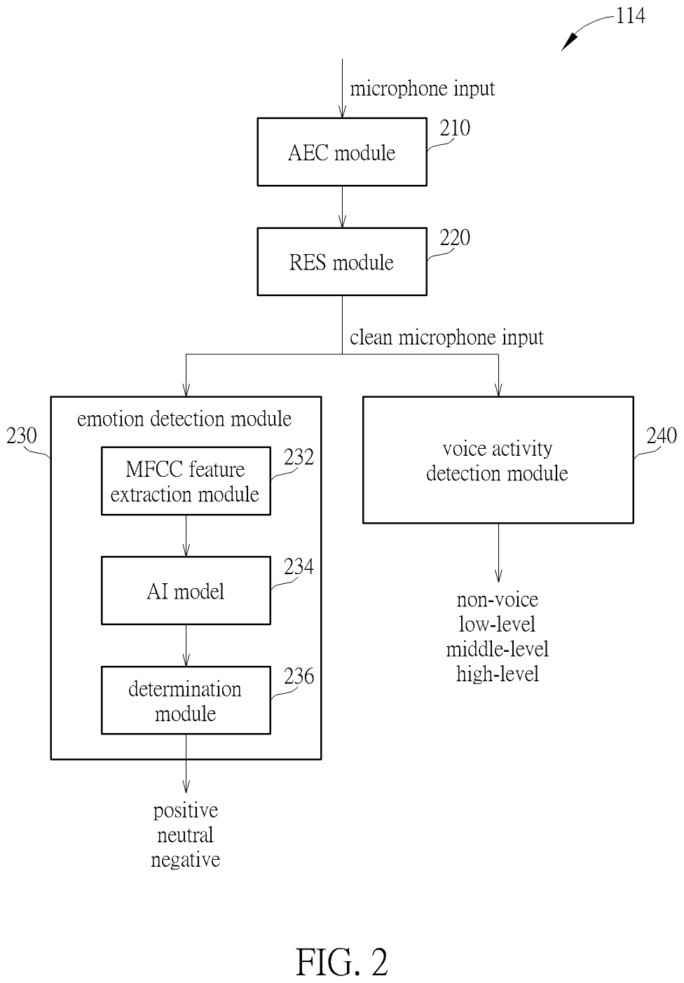

FIG. 2 is a diagram illustrating the user hotspot detection module 114 according to one embodiment of the present invention. As shown in FIG. 2, the user hotspot detection module 114 comprises an acoustic echo cancellation (AEC) module 210, a residual echo suppression (RES) module 220, an emotion detection module 230 and a voice activity detection (VAD) module 240, wherein the emotion detection module 230 comprises a Mel-scale frequency cepstral coefficients (MFCC) feature extraction module 232, an artificial intelligence (AI) model 234 and a determination module 236.

In the operation of the user hotspot detection module 114, because the microphone input comprises human voice, speaker sound (echo) and environment noise, the AEC module 210 and the RES module 220 cancel or reduce the echo and the environment noise to generate clean microphone input. For example, the AEC module 210 is based on an adaptive finite impulse response (FIR) filter, and the AEC module also calculates a residual signal containing nonlinear acoustic artifacts, and this signal is sent to the RES module 220 to recover the microphone input signal. Because the designs and detailed operations of the AEC module 210 and the RES module 220 are known by a person skilled in the art, further descriptions are omitted here.

The VAD module 240 is also known as speech activity detection or speech detection, and is the detection of the presence or absence of human voice or human speech. In the operation of the VAD module 240, the clean microphone input is divided into many sections, and each section is calculated to obtain many features, and a classification rule is applied to classify the section as speech or non-speech based on whether a value calculated according to the features exceeds a threshold. In addition, when the VAD module 240 determines that the microphone input comprises human speech or human voice, the VAD module 240 will also determine strength of the human voice. In this embodiment, the VAD result may comprise information about whether the clean microphone input is non-voice signal, low-level human voice, middle-level human voice or high-level human voice. Because the designs and detailed operations of the VAD module 240 are known by a person skilled in the art, further descriptions are omitted here.

In the operations of the emotion detection module 230, the MFCC feature extraction module 232 performs some operations such as Fourier transform, mel-scale mapping, discrete cosine transform, etc., on the clean microphone input to generate MFCC features. Because the designs and detailed operations of the MFCC feature extraction module 232 are known by a person skilled in the art, further descriptions are omitted here. Then, the AI model 234 is configured to receive the MFCC features to generate the corresponding human emotion, wherein the AI model 234 may analyze the MFCC features to determine if the clean microphone input corresponds to angry, happy, neutral, sad, silence or other emotions. Then, the determination module 236 generates an user emotion detection result indicating if the clean microphone input corresponds to a positive emotion, a neural emotion or a negative emotion, wherein the positive emotion comprises happy, the negative emotion comprises angry and sad, and the neutral emotion comprises neutral, silence and other emotions.

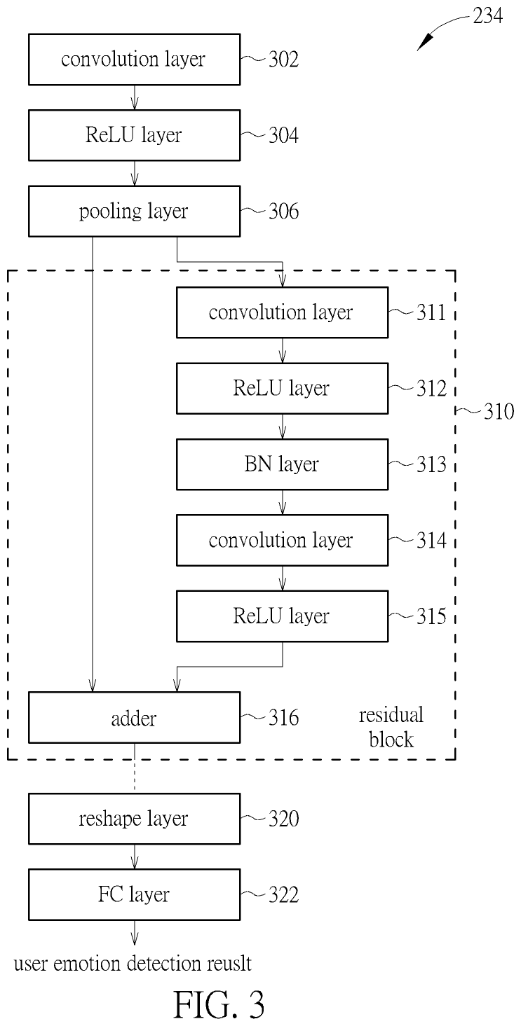

FIG. 3 is a structure of the AI model 234 according to one embodiment of the present invention. As shown in FIG. 3, the AI model 234 comprises has a convolution layer 302, a rectified linear unit (ReLU) layer 304, a polling layer 306, a residual block 310, a reshape layer 320 and a fully-connected (FC) layer, wherein the residual block 310 comprises convolution layer 311, a ReLU layer 312, a batch normalization (BN) layer 313, a convolution layer 314, a ReLU layer 315 and an adder 316. The structures of the AI model 234 are known by a person skilled in the art, and this embodiment focuses on the training and the use the AI model 234. In the training phase of the AI model 234, the engineer provides many audio clips for training, testing and validation, wherein the audio clips comprise the above emotions such as angry, happy, neutral, sad or silence. In addition, these audio clips may be processed under some data augmentation techniques to increase the variety, such as vocal track length normalization, pitch shift, time stretch, data shift in time domain and/or noise adding.

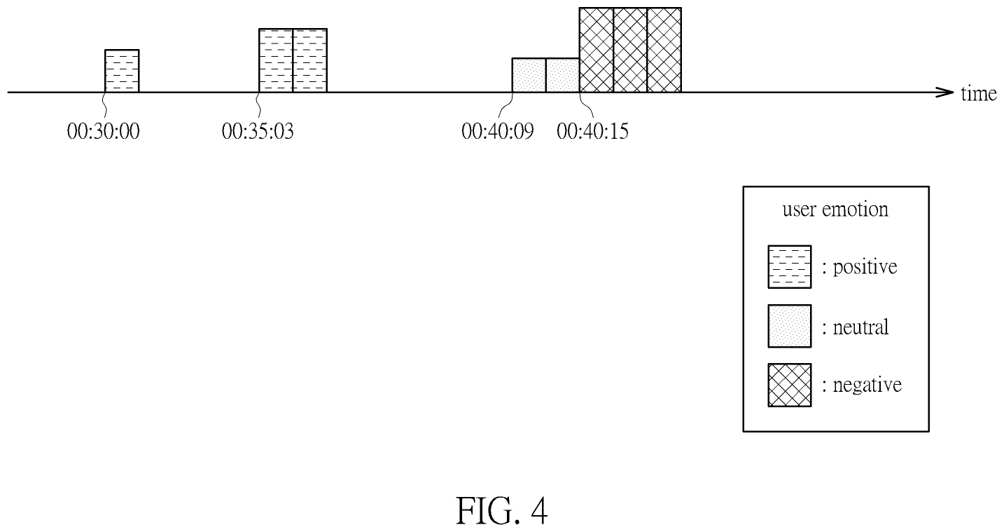

FIG. 4 shows the user hotspot detection results generated by the user hotspot detection module 114 according to one embodiment of the present invention. As shown in FIG. 4, the user hotspot detection results comprise the VAD results generated by the VAD module 240 and the user emotion detection results generated by the emotion detection module 230. Specifically, the user hotspot detection results have information of the user emotions and corresponding timing. For example, the user hotspot detection results indicate that the user was in a positive mood at 00:30:00 of the video, the user was in the positive mood at 00:35:03 of the video, the user was in the neutral mood at 00:40:09 of the video, and the user was in the negative mood at 00:40:15 of the video.

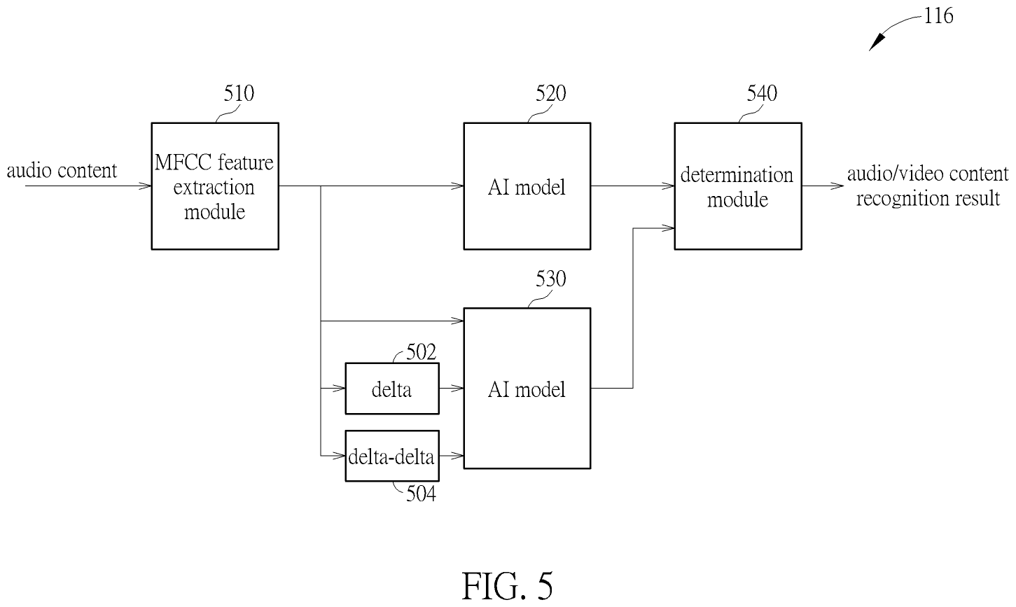

FIG. 5 is a diagram illustrating the audio/video content recognition module 116 according to one embodiment of the present invention. As shown in FIG. 5, the audio/video content recognition module 116 comprises a MFCC feature extraction module 510, two AI models 520 and 530, a delta operator 502, a delta-delta operator 504, and a determination module 540.

In the operation of the audio/video content recognition module 116, the MFCC feature extraction module 510 performs some operations such as Fourier transform, mel-scale mapping, discrete cosine transform, etc., on the audio content to generate MFCC feature. Then, the AI model 520 is configured to receive the MFCC feature to generate the corresponding audio content recognition, wherein the AI model 520 may analyze the MFCC feature to determine if the audio content that is to be played by the speaker 130 corresponds to happy, sad, angry or other contents. The structure and the training steps of the AI model 520 are similar to those of the AI model 234 shown in FIG. 3. In addition, in order to improve the recognition accuracy, the AI model 530 is provided to use the additional features, such as the outputs of the delta operator 502 and the delta-delta operator 504, to determine if the audio content that is to be played by the speaker 130 corresponds to happy, sad, angry or other contents. Then, the determination module 540 outputs an audio/video content recognition result indicating if the audio content corresponds to happy, sad, angry or other contents according to the outputs of the AI models 520 and 530.

In addition, the audio/video content recognition module 116 shown in FIG. 5 is for illustrative, not a limitation of the present invention. In other embodiments of the present invention, the delta operator 502, the delta-delta operator 504 and the AI model 530 can be removed from the audio/video content recognition module 116, and the determination module 540 generates the audio content recognition result according to the output of the AI models 520 only. This alternative design shall fall within the scope of the present invention.

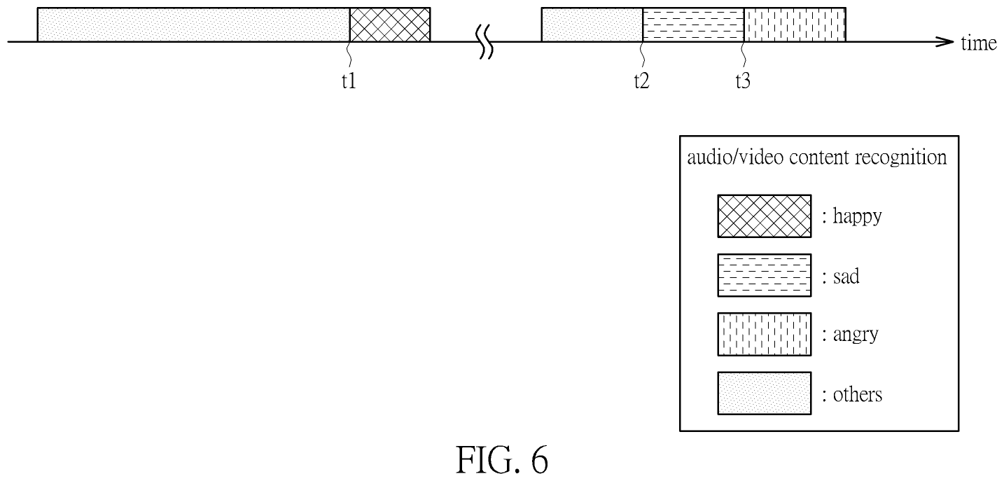

FIG. 6 shows the audio content recognition results generated by the audio/video content recognition module 116 according to one embodiment of the present invention. As shown in FIG. 6, the audio content recognition results have information of the audio contents and corresponding timing. For example, the audio content recognition results indicate that the audio content has a happy content at t1 of the video, the audio content has a sad content at t2 of the video, and the audio content has an angry content at t3 of the video.

In light of above, by using the user hotspot detection module 114 to obtain the user hotspot detection results, the electronic device 100 can get users' reaction when they watch the video. In addition, by using the audio/video content recognition module 116 to obtain the audio/video content recognition results, the electronic device 100 can obtain the classifications of segments of the video. The user hotspot detection results and/or the audio/video content recognition results can be used by the video application companies to provide better services for the users, for example, the video application companies or the streaming service may insert suitable advertisements or personal recommendations at some specific times of the video.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A processing circuit of an electronic device, comprising:
an audio/video content generation module, configured to generate audio data and video data to a speaker and a display panel, respectively; and
a user hotspot detection module, configured to receive a microphone input from a microphone of the electronic device, and detect the microphone input to generate a user hotspot detection result when the speaker plays the audio data and the display panel shows the video data; and
an output module, configured to store the user hotspot detection result.

2. The processing circuit of claim 1, wherein the user hotspot detection module comprises:
an acoustic echo cancellation (AEC) module, configured to cancel or reduce an echo or the environment noise to generate a clean microphone input; and
an emotion detection module, configured to generate an user emotion detection result indicating which user emotion the clean microphone input corresponds to.

3. The processing circuit of claim 2, wherein the emotion detection module comprises:
a Mel-scale frequency cepstral coefficients (MFCC) feature extraction module, configured to receive the clean microphone input to generate MFCC features;
an artificial intelligence (AI) model, configured to receive the MFCC features to generate corresponding emotion; and
a determination module, configured to generate an user emotion detection result according to the emotion determined by the AI model.

4. The processing circuit of claim 2, wherein the user hotspot detection module further comprises:
a voice activity detection (VAD) module, configured to detect if the clean microphone input comprises human voice or human speech to generate a VAD result.

5. The processing circuit of claim 4, wherein the user hotspot detection module generates the user hotspot detection result according to the user emotion detection result and the VAD result.

6. The processing circuit of claim 5, wherein the user hotspot detection result comprises information of the user emotion and corresponding timing of audio/video content.

7. The processing circuit of claim 1, further comprising:
an audio/video content recognition module, configured to recognize audio content corresponding to the audio data to generate an audio/video content recognition result;
wherein the output module further stores the audio/video content recognition result.

8. The processing circuit of claim 7, wherein the audio/video content recognition module comprises:
a MFCC feature extraction module, configured to receive the audio content to generate MFCC features;
an AI model, configured to receive the MFCC features to determine corresponding content; and
a determination module, configured to generate an audio/video content recognition result according to the content determined by the AI model.

9. A processing method of an electronic device, comprising:
generating audio data and video data to a speaker and a display panel, respectively;
receiving a microphone input from a microphone of the electronic device;
detecting the microphone input to generate a user hotspot detection result when the speaker plays the audio data and the display panel shows the video data; and
storing the user hotspot detection result.

10. The processing method of claim 9, wherein the step of detecting the microphone input to generate the user hotspot detection result when the speaker plays the audio data and the display panel shows the video data comprises:
cancelling or reducing an echo or the environment noise to generate a clean microphone input; and
generating an user emotion detection result indicating which user emotion the clean microphone input corresponds to.

11. The processing method of claim 10, wherein the step of detecting the microphone input to generate the user hotspot detection result when the speaker plays the audio data and the display panel shows the video data further comprises:
detecting if the clean microphone input comprises human voice or human speech to generate a voice activity detection (VAD) result.

12. The processing method of claim 11, wherein the step of detecting the microphone input to generate the user hotspot detection result when the speaker plays the audio data and the display panel shows the video data further comprises:
generating the user hotspot detection result according to the user emotion detection result and the VAD result.

13. The processing method of claim 12, wherein the user hotspot detection result comprises information of the user emotion and corresponding timing of audio/video content.

14. The processing method of claim 9, further comprising:
recognizing audio content corresponding to the audio data to generate an audio/video content recognition result; and
storing the audio/video content recognition result.
